(19) United States
(12) Patent Application Publication
(10) Pub. No.: US 2025/0370759 A1
(43) Pub. Date: Dec. 4, 2025

(54) SYSTEM AND METHOD FOR EFFICIENT BOOT LOGGING IN EMBEDDED SYSTEMS

(71) Applicant: Calix, Inc., San Jose, CA (US)

(72) Inventors: Feixia Duan, Nanjing Jiangsu (CN); Tian Deng, Nanjing Jiangsu (CN); Hao Wu, Nanjing Jiangsu (CN)

(21) Appl. No.: 18/737,187

(22) Filed: Jun. 7, 2024

(30) Foreign Application Priority Data
May 29, 2024 (CN) 2024106834072

(51) Int. Cl. G06F 9/4401; G06F 11/07

(52) U.S. Cl. CPC G06F 9/4401; G06F 11/0787

(57) ABSTRACT

A system for efficient boot logging in embedded systems that records boot event logs and failure operation logs in flash storage and optimizing write operations for longevity. Defined regions in flash reserve space for data blocks organized into fixed sizes. Logs are appended by locating free blocks without erase operations. A state machine limits logging duplicate failure events. The system comprises a boot loader, flash memory, and logic to manipulate data regions. The method manages defined flash regions, locates free blocks, writes record headers and log payloads, and updates record states when logging repetitive failures. Binary search algorithms efficiently find last written blocks. Embodiments can be used for embedded systems that use boot loaders to initialize system hardware and load operating systems.

### TECHNICAL FIELD

Embodiments relate to the field of embedded systems, and more particularly, to efficient boot logging in embedded systems.

### BACKGROUND

An embedded system is generally a microcontroller or microprocessor-based system that combines computer hardware and software designed to perform a specific function. Such a system is often integrated or embedded within a larger system to perform the function, or it may be configured as an independent unit. Embedded systems can range in complexity from single chip solutions to multi-circuit systems for virtually any computing application such industrial machines, communications, consumer electronics, personal devices, automobiles, medical equipment, point-of-sale terminals, and so on.

Part of the software included in an embedded system includes a resident operating system (OS), and embedded systems commonly use boot loaders to initialize system hardware and load the operating system. In some cases, such as due to hardware/software design or operational failures, it is necessary to power cycle or restart the embedded system during the boot process to try to recover the system as deployed for use. For such abnormal operations during the boot process, it is necessary to store the operation log to memory for further analysis and debugging. Capturing logs during the boot process is thus very important for diagnosing hardware or software failures. Typical boot loaders, however, have limited ability to write logs persistently since writable storage is not available early in the boot sequence.

To avoid this problem, non-volatile memory (e.g., flash memory) is often used to store firmware images. Flash endurance is limited, however, making it impractical to repeatedly erase flash sectors to write log data. The lifetime of present-generation flash devices is about 100000+ erases per sector. Before writing data to flash, an entire sector needs to be erased if any bit of the data is changed from 0 to 1. To ensure as long a device life as possible and to avoid data loss, systems should avoid or minimize erasing flash memory during boot operations.

What is needed, therefore is a way to efficiently append boot logs in flash memory while minimizing erasures of this memory.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### SUMMARY OF EMBODIMENTS

A method for logging boot and abnormal operations in an embedded system having non-volatile memory partitioned into a startup log partition and an abnormal operation log partition, comprising executing a boot loader process to execute boot code to start up the embedded system, storing boot event records of the boot loader process in the startup log partition, and storing abnormal event records in the abnormal operation log partition for any abnormal events encountered during the start up. The non-volatile memory may comprise a NOR-type flash memory device. The boot loader initializes system hardware and loads an operating system into the non-volatile memory. System hardware includes one or more peripheral devices used by the embedded system, and coupled to the embedded system through respective logical and physical interfaces.

The abnormal events may comprise at least one of a failure of a peripheral device, a failure of a logical or physical interface, or a failure of hardware or software performing the start up.

The method further comprises defining a record header for each record stored in the non-volatile memory, the header containing a state, signature, version, payload length, and cyclic redundancy check and a state of a respective record, and wherein the state comprises the status of a corresponding record. The state comprises the status of a corresponding record, and further comprising maintaining, in the boot record, a one-bit field indicating whether record has been dumped by an application.

The method further comprises identifying a next available block to store a new record within the startup log partition or abnormal operation log partition. The identifying step comprises may use a binary search operation. The state transitions between bit states 0 and 1 upon logging a repetitive abnormal operation to prevent storage of duplicative abnormal operation logs in the abnormal operation log partition.

The method may further comprise checking whether or not a partition is full, and erasing, for a full partition, in a cleanup operation the entire partition by sectors for a next reboot operation to store logs. The cleanup operation erases the sectors in reverse order. The method further comprises providing the boot event records to a user or set of debugging tools for product improvement.

A system for storing boot logs in non-volatile memory of an embedded system, comprises a boot loader component executing boot code using a processor of the embedded system to initialize system hardware and load an operating system into memory, a non-volatile memory storing the boot code, and comprising a first region storing blocks for boot event records, and a second region storing blocks for operation failure records, and an interface to transmit the boot event records and operation failure records to a user for system review purposes. The system may further comprise processing logic configured to locate a next available block for writing a new record into the non-volatile memory through a binary search operation within the first region or second region. The blocks further comprise a record header containing a cyclic redundancy check and a state. The state transitions upon logging a repetitive failure to avoid duplicate records. The non-volatile memory may comprise a NOR-type flash memory device.

The system hardware can include one or more peripheral devices used by the embedded system, and coupled to the embedded system through respective logical and physical interfaces, and wherein a failure comprises at least one of a failure of a peripheral device, a failure of a logical or physical interface, or a failure of hardware or software performing the start up.

A method for boot logging in embedded devices by executing a boot loader sequence on a processor, appending boot event records to a first region in non-volatile memory, locating available blocks in the first region for new records without erase operations, and extracting boot records after successful system startup. The method may further comprise transitioning the state in a record header if logging a duplicate failure event.

Appending records further comprises writing record headers containing CRC values and sequence numbers.

The embedded devices comprise a system including one or more peripheral devices coupled through respective logical and physical interfaces, and wherein a failure comprises at least one of a failure of a peripheral device, a failure of a logical or physical interface, or a failure of hardware or software performing the start up.

### BRIEF DESCRIPTION OF DRAWINGS

In the following drawings like reference numerals designate like structural elements. Although the figures depict various examples, the one or more embodiments and implementations described herein are not limited to the examples depicted in the figures.

FIG. 1 illustrates an embedded system implementing efficient boot logging for flash memory, under some embodiments.

FIG. 2 illustrates a structure of an example NOR flash device, under some embodiments.

FIG. 3 illustrates embedded system bootup code stored in flash memory, under some embodiments.

FIG. 4 illustrates an example region as partitions on flash layout, under some embodiments.

FIG. 5 illustrates a layout of a region in flash with example headers and payloads, under some embodiments.

FIG. 6 is a flowchart that illustrates a method of efficient boot logging in an embedded system, under some embodiments.

FIG. 7 illustrates an example boot log state transition, under some embodiments.

FIG. 8 illustrates an example abnormal operation log state transition, under some embodiments.

FIG. 9 illustrates an example power cycle log state transition, under some embodiments.

FIG. 10 illustrates an example abnormal operation log state transition for the boot loader of FIG. 9, under an embodiment.

FIG. 11 illustrates an example of finding a last valid block, under some embodiments.

FIG. 12 illustrates recording an abnormal operation log, under some embodiments.

FIG. 13 illustrates an example of dumping application logs, under an embodiment.

FIG. 14 illustrates erasing sectors in a cleanup operation, under some embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence, nor constrained to a particular system configuration. Additionally, some of the described embodiments or elements thereof can be combined, occur, or be performed simultaneously, at the same point in time, or concurrently.

It should be noted that the described embodiments can be implemented in numerous ways, including as a process, an apparatus, a system, a device, a method, or a computer-readable medium containing computer-readable instructions or computer program code, or as a computer program product having computer-readable program code embodied therein. In the context of this disclosure, a computer-usable medium or computer-readable medium may be any physical medium that can contain or store the program for use by or in connection with the instruction execution system, apparatus or device.

Reference will now be made in detail to the disclosed embodiments, examples of which are illustrated in the accompanying drawings. Unless explicitly stated, sending and receiving as used herein are understood to have broad meanings, including sending or receiving in response to a specific request or without such a specific request. These terms thus cover both active forms, and passive forms, of sending and receiving.

Certain computer systems including embedded systems, such as rackmount system, allow a hot swap (or hotswap) operation where components or boards can be removed and/or installed while power is kept on. This allows parts to be changed without shutting down or rebooting the server or system. A hotswap operation can also involve a system restart process that is initiated by software when a hardware problem has occurred. In this case, it is important to log and store the system state during each hotswap so that specific issues causing any problem can be identified and addressed. Log data cannot be stored in volatile memory (e.g., DRAM) because contents can be lost during any power cycling, and hence, non-volatile memory, such as flash memory must be used. However, as described above, flash memory devices have certain longevity limitations with respect to the number of times they can be erased.

Embodiments include a system and method to record boot event logs and failure operation logs in flash storage and optimizing write operations for longevity. Defined regions in flash reserve space for data blocks organized into fixed sizes. Logs are appended by locating free blocks without erase operations, and a state machine limits logging duplicate failure events. A system comprises a boot loader, flash memory, and logic to manipulate data regions. The method manages defined flash regions, locates free blocks, writes record headers and log payloads, and updates record states when logging repetitive failures. Binary search algorithms efficiently find last written blocks.

Within the flash memory storing firmware images of the system, a region can be divided into multiple sectors, and a sector can be divided into multiple blocks, where a block can store a boot log (or start up log). To fully utilize every block and avoid unnecessary erasing, the blocks are written sequentially to maximize usage of the flash. This can be achieved by using a bisection method to quickly locate a next blank block. A boot log has multiple fields, including a header field. The header of each log is utilized to minimize writing to the flash and to terminate multiple or endless hot swapping of the hardware. To minimize the effect on flash, the system avoids writing multiple blocks for the same reason. Instead, the header of the last log is changed to indicate how many times the hardware has been restarted for the same reason. The system utilizes another nature of flash, which is that a write of binary 1 to binary 0 can be written directly without erasing first. Thus, the changes are done according to some predefined ways to make sure that changes made to the header do not cause erasing the flash. In addition, if the header indicates multiple restarts of the hardware for the same reason, a process can terminate the endless hotswap cycle. The header is also used to facilitate a log dump, as it also indicates whether the log has been fetched. Once the log has been fetched, the header is changed to indicate that state.

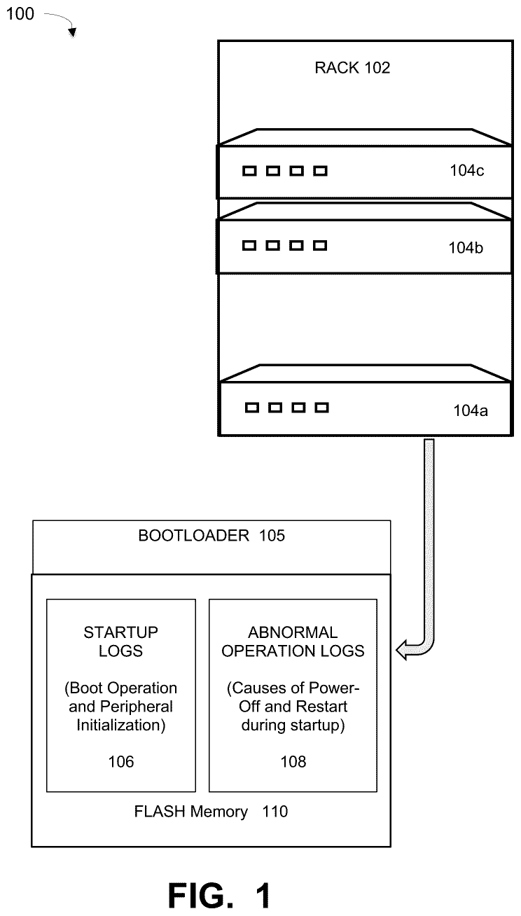

FIG. 1 illustrates an embedded system implementing efficient boot logging for flash memory, under some embodiments. As shown in FIG. 1, system 100 includes a number of computer boards or similar embedded components 104a, 104b, and 104c. For the example embodiment shown, these can be rack-mountable computer boards mounted in a rack 102, and that can be removed and installed in the rack during constant power on. Each computer or component includes flash memory 110 as a storage resource and executes a boot loader 105 that utilizes this flash memory.

For the embodiment of system 100, two partitions are defined within the flash memory space, one part is used to store startup logs 106, and the other part is used to store abnormal operation logs 108, as illustrated for computer 104a.

The startup log 106 includes the core bus of the boot loader and the initialization processes of peripheral devices. The abnormal operation log is used to record the causes of power-off and restarts during the startup process, such as component failures, failure to scan peripheral devices, and so on. The peripheral devices generally comprise devices that can be coupled to the embedded system through one or more physical and/or logical interfaces, and can include I2C, PCI-e, USB, SPI, FPGA, CPLD, EMMC, SATA, NVME, and similar devices.

As shown in FIG. 1, the flash memory component is thus divided into discrete data regions. As will be described below, these regions contain configuration sectors defining block size, offsets, and other relevant information, and the blocks consist of a header (magic, state, CRC, etc.) and log payload.

Embodiments include logic processes that first find free blocks via binary search without erasing. A record header is written with sequence number, lengths, CRC, and initial state. Boot logs are appended to a first region of the flash (startup log), and failure logs are appended to a second region of the flash (abnormal operation log). Before logging failures, the system checks the last record state using finite state machine, and updates the state on duplicate events to avoid redundant logging. Host software extracts logs after a successful boot by reading valid blocks.

In an embodiment, the flash memory comprises a NOR flash device. NOR flash devices generally support up to 100,000 erasures per sector over an average lifetime. A blank device is programmed with all binary 1 bit values. No erase is needed for a 1 to 0 bit change, however, for a 0 to 1 bit change, the entire sector needs to be erased.

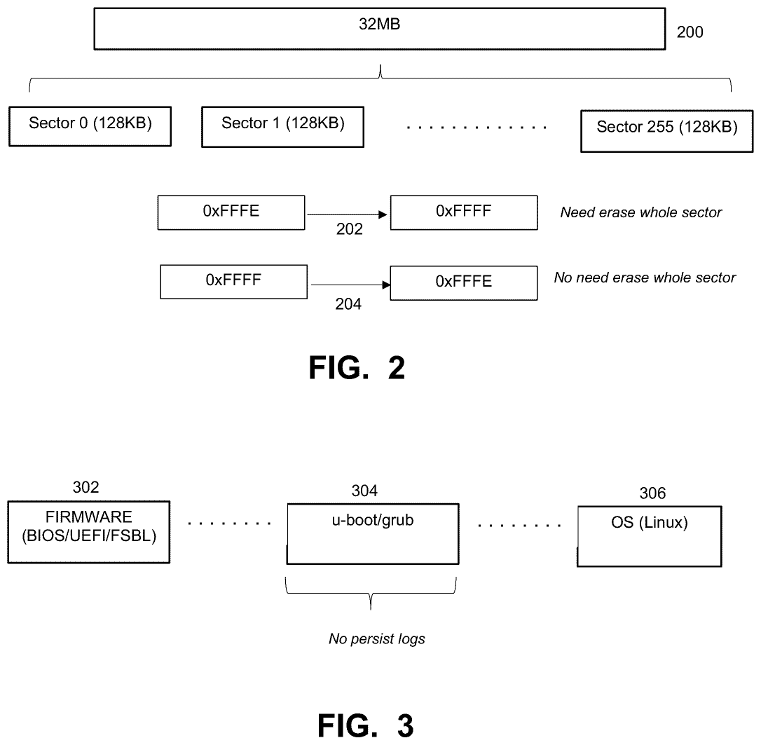

FIG. 2 illustrates a structure of an example NOR flash device, under some embodiments. FIG. 2 illustrates a 32 MB flash device 200 that is divided into 256 sectors denoted sector 0 to sector 255 and that are each 128 KB in size. Other sizes and structures are also possible. As described above, a change in state within a sector involving a 0 to 1 bit change, such as from 0xFFFE to 0xFFFF (202) requires that the whole sector be erased, while a change in state within a sector involving a 1 to 0 bit change, such as from 0xFFFF to 0xFFFE (204) does not require an erase.

Although embodiments are described with respect to NOR flash devices, embodiments are not so limited and other flash or non-volatile memory types may also be used.

In an embedded system, the flash memory stores the system bootup code. Generally no file system is provided in the flash memory, instead only basic firmware, boot code, and operating system code is provided. FIG. 3 illustrates embedded system bootup code stored in flash memory, under some embodiments. As shown in FIG. 3, the flash device (e.g., 200 of FIG. 2) contains firmware (BIOS/UEFI/FSBL) 302, bootcode 304, and an operating system (e.g., Linux) 306.

For the example shown the bootcode comprises u-boot/grub and has no persist logs. The u-boot/grub program is a general boot loader widely applied in embedded systems and will load the operating system. It also performs some hardware initialization before loading the operating system (e.g., Linux). Other boot loaders may also be used. The boot loader will output the logs to console and not persist. If there is a system error at this point, it is generally difficult to determine the problem. It should be noted that the operating system can be loaded into any appropriate system memory by the boot code, such as volatile memory, non-volatile memory, or any other storage or combination of memory, depending on system configuration and constraints.

As shown in FIG. 1, two partitions are extracted from the FLASH space, one that is used to store startup logs 106, and the other that is used to store abnormal operation logs 108. The startup log includes the core bus of the boot loader and the initialization process of peripheral devices, and the abnormal operation log is used to record the reasons for power-off and restart during the startup process, such as failure to scan peripherals, and so on.

According to the flash characteristics of different products, the system sets the log partition size of the flash to m (in units of MB), and the erase/write unit of the flash sector to n (in units of KB). The total size of each record including record header information is 128 bytes, so the total block count per partition should be (m*1024*1024)/128, which is denoted as variable x (unit: 1). The block size can be applied as 4 bytes alignment and can be 32 bytes, 64 bytes, 128 bytes, 256 bytes, and so on, as defined by user detail application design.

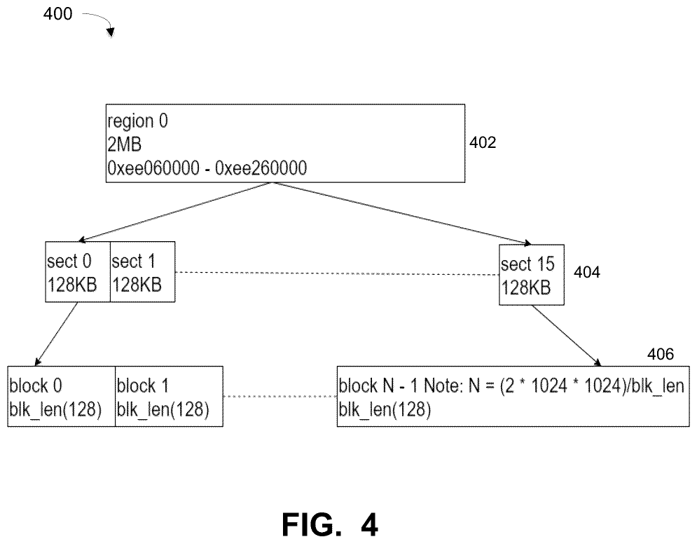

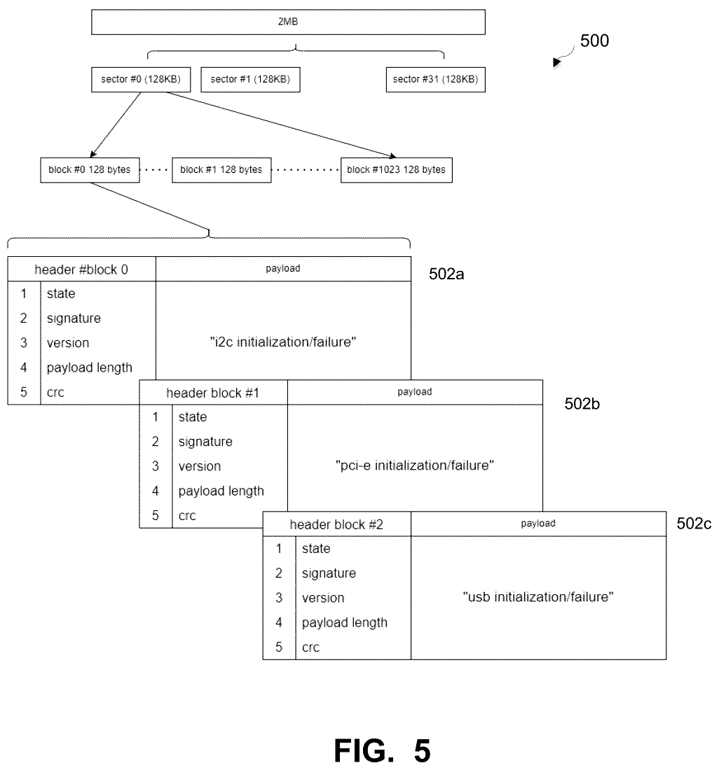

FIG. 4 illustrates an example region as partitions on flash layout, under some embodiments. As shown in FIG. 4, flash device 400 includes a region 0 of size 2 MB. For the example shown, the Region 0 base address is 0xee060000 and the end address is 0xee260000. 0xee060000 is an physical address which the CPU can access it directly from boot loader. For different systems, this address may be changed or the flash access interface may be different. The overall region 402 is divided into 16 sectors 404 of 128 KB each and denoted sector 0 to sector 15. These sectors then contain the blocks 406 denoted block 0 to block N−1, where N is the total block count per partition as calculated using the formula above.

Each block 406 contains a header and payload. The header specifies a specific data type, and the payload comprises the content data. In an embodiment, record header information includes the following information: state, signature, version, payload length, and cyclical redundancy check (crc). The state is the status of this record (by default, set to all 1). The version is version number of the record and can be used to provide for expansion if necessary for a user to add more members to the header. The signature is used to indicate whether the record is valid or not. The payload length (data_len) is the number of bytes of the record. The crc is a binary value where crc_h is a high 16 bit crc value of the record, and crc_1 is low 16 bit crc value of the record. Next to the header is the payload that is stored. In general, each record's length is limited to the block length minus the size of the header.

FIG. 5 illustrates a layout of a region in flash with example headers and payloads, under some embodiments. Diagram 500 of FIG. 5 illustrates the flash device 400 of FIG. 4 with example headers 502a, 502b, 502c for some of the blocks (block 0 to block 1024). Each header comprises five fields: state, signature, version, payload length, and crc. For the example of FIG. 5, the payload indicates an initialization or failure of a particular peripheral device, such as a i2c, pci-e, usb device, and so on.

For the example shown in FIG. 5, each block will store the data and its data length is 128 bytes in total. The data is comprised of header and payload, and the header could be a fixed length. The remaining part is the payload, which can be text format or structure format. For example, the payload part can be filled with a text message like “i2c initialization failure.” As to this payload, the header's member “payload length” used to indicate how many bytes are valid for this payload, that can be used by an application to dump it into human readable format, or a user can define the payload as its own format (e.g., binary/structure format), or as some user-defined enumeration data or err code number. For an example, a payload filled with 0x1, can represent “i2c initialization failure” and header's payload length is set as 1 byte, or a payload filled with 0x2 can represent “pci-e initialization failure,” and so on.

In an example embodiment, the data structure of the header can be defined as follows:

```
typedef struct data_hdr_t {
  state; /* tag to indicate whether the block state */
  version; /* version of the hdr */
  signature; /* signature */
  data_len; /* data length for current block */
  data_crc_h; /* data crc32 high 16 bit */
  data_crc_l; /* data crc32 low 16 bit */
} data_hdr_t;
```

The header and payload are linked as a log record. A user can put the log's information (text format/user defined code) into the payload. Each time this is done, one log will cost one data block and is stored into flash memory in sequence.

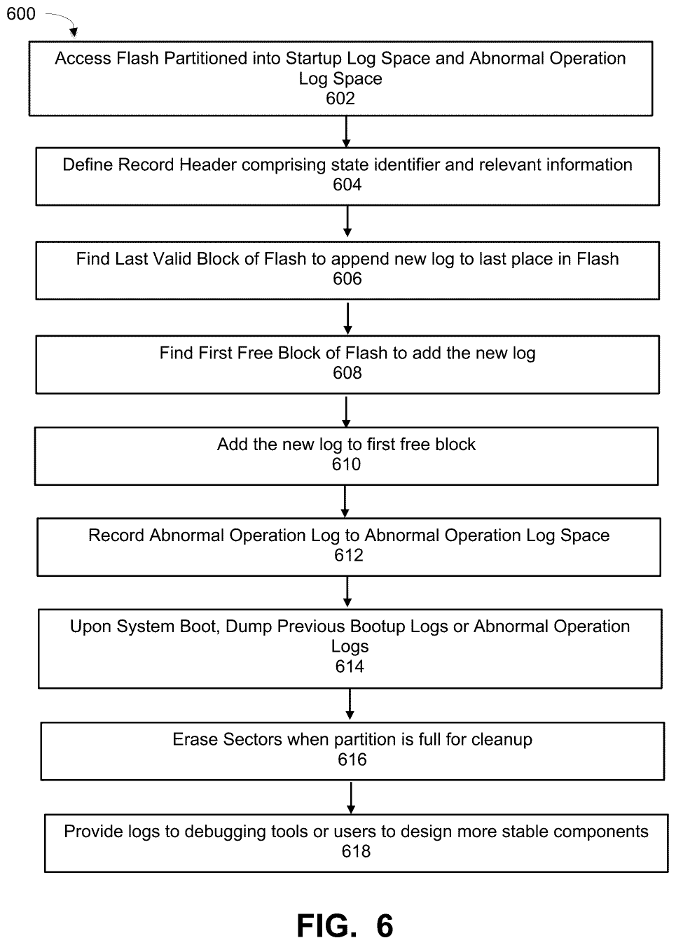

FIG. 6 is a flowchart that illustrates a method of efficient boot logging in an embedded system, under some embodiments. As shown in FIG. 6, process 600 begins with accessing flash memory that is partitioned into startup log and abnormal operation log partitions 602, and defining record headers for the logs 604, as described above. As stated above, the startup log 106 includes the core bus of the boot loader and initialization of the peripheral devices, and the abnormal operation log or logs record reasons for power-off and restarts during system startup.

In an embodiment, the efficient boot logging process appends to the first empty block when adding a new log into flash in order to guarantee write balance and avoid operations per sector to save flash longevity. It thus appends new logs after the last utilized place. In an embodiment, to quickly locate the last place when inserting the new log, the process applies a binary search operation.

The boot log records operations when the embedded system starts up and initializes the peripheral devices. These operations essentially cause certain state transitions in the system. The system thus provides state transition logic for the boot log. During boot up, it will record logs in sequence per block into the NOR flash partition. During this phase, all of the logs' initial states should be all Is under the header region. If there is a reboot again during this procedure, all of these logs' states will be kept and not changed. A next boot will record logs again, and these new logs will be recorded into free places in sequence. For previous reboot logs' state and current boot logs' state are both all 1s.

Once an application boots up normally, the application will dump these boot logs and update the state field of each log's header. This update only needs to change one bit of the state field from 1 to 0. Under this logic, the whole operation will not include any erase operations to the NOR flash.

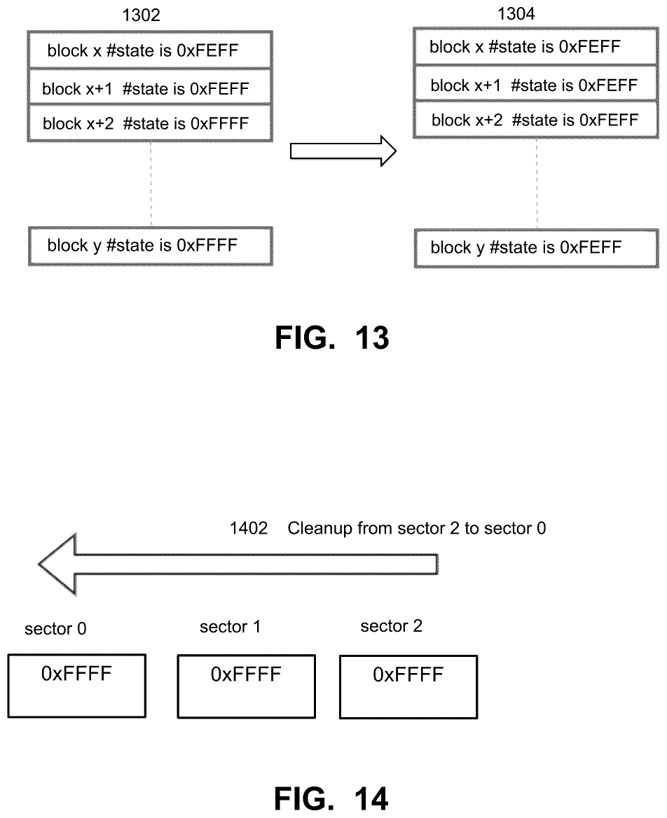

If there is no extra reboot, once the boot loader boots up the OS and the application starts to dump the boot logs recorded by the boot loader. Under the dump operation, each logs' state will be updated from all Is to one bit of the field changed into 0. This is used to indicate that current boot logs have been fetched by the application, which can help avoid dumping history boot logs. An example state transition is explained and illustrated below with reference to FIG. 13.

In an initial flash state, all bits may be set to binary 1 values. Any change of a bit from 1 to 0 does not require a need to erase the sector, however a change from 0 back to 1 does require the entire sector to be erased. In an embodiment, the system includes a follow bit field to indicate whether the boot log has been dumped by application. During boot up, its initial state is all 1s. When the application starts and dumps the boot log, the application will update the state's bit field to 0, to indicate that the log has been dumped.

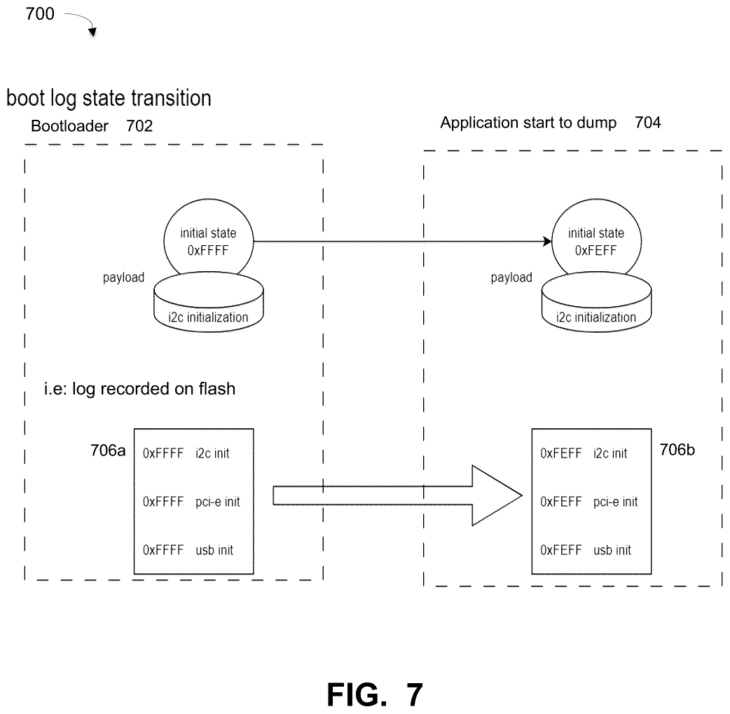

FIG. 7 illustrates an example boot log state transition, under some embodiments. The example diagram 700 of FIG. 7 includes a first boot loader state 702 and a state 704 of the boot loader as dumped when the application starts. As shown for the example of FIG. 7, the initial state of the boot loader for a payload “i2c initialization” goes from 0xFFFF to 0xFEFF after the application starts to dump. The boot up records three bootup logs 706a, namely: “i2c init”, “pci-e init”, “usb init”. After application boot up, these three records dumped to form records 706b, and their state bit fields are updated from 1 to 0 upon taking three boot logs stored into the block, as an example.

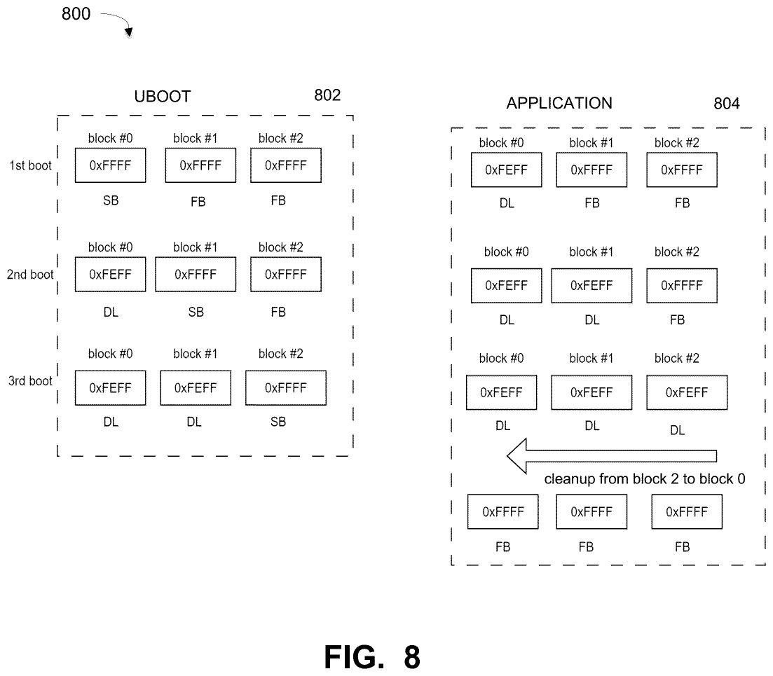

FIG. 8 illustrates an example abnormal operation log state transition, under some embodiments. This transition is generally similar to the boot log's state transition (as illustrated in FIG. 7), while it will pick up more bit fields, which are used to avoid saving identical causes into the flash and reuse the data block as much as possible. The example diagram 800 of FIG. 8 includes example blocks of the UBOOT code 802 and blocks of the application 804 when the application starts.

For sake of brevity, the example of FIG. 8 shows a boot record of only one log for a total three blocks. In the diagram, free blocks are denoted “FB,” blocks when the log is dumped are denoted “DL,” and logs stored but not dumped are denoted “SB.”

The boot record keeps one bit field as the state to indicate whether a corresponding record has been dumped by the application. In the illustrated example, the user can apply four bits to retry four times in case of a same abnormal reboot (e.g., hotswap/cold reboot/power cycle). The user can check the field value to verify whether it can keep one or more retries. For example:
0xF7FF->0xF3FF: keep 2 times retry.
0xF7FF->0xF7FF: keep 1 time retry.
0xF7FF->0xF1FF: keep 3 times retry.
0xF7FF->0xFOFF: keep 4 times retry.
0xF7FF->0xF07F: keep 5 times retry.

The user can apply more bit fields to implement more times retry logic for the same reason.

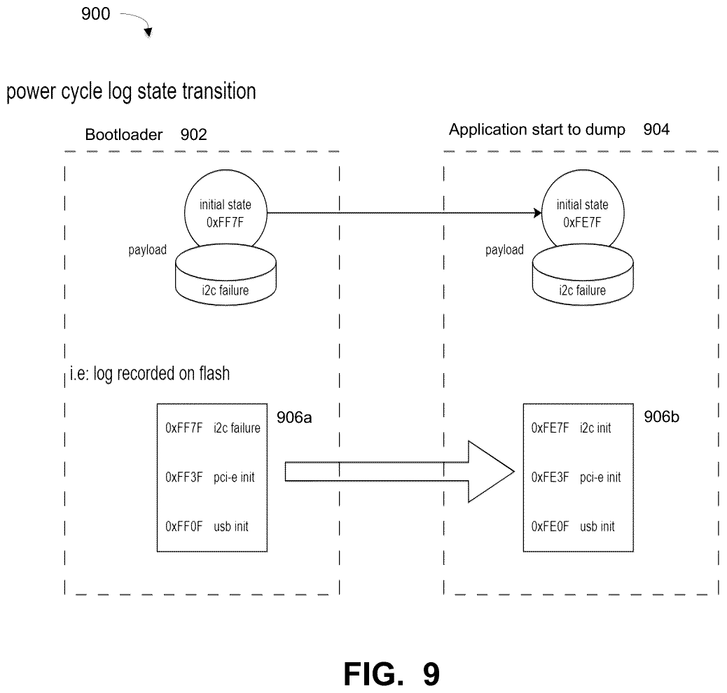

FIG. 9 illustrates an example power cycle log state transition, under some embodiments. The example diagram 900 of FIG. 9 includes a first boot loader state 902 and a state 904 of the boot loader as dumped when the application starts. As shown for the example of FIG. 9, the initial state of the boot loader for a payload “i2c failure” goes from 0xFF7F to 0xFE7F after the application starts to dump. The boot up records three bootup logs 906a, namely: “i2c failure”, “pci-e init”, “usb init”. After application boot up, these three records dumped to form records 906b, and their state bit fields are updated.

FIG. 10 illustrates an example abnormal operation log state transition for the boot loader of FIG. 9, under an embodiment. The example diagram 1000 of FIG. 10 includes example blocks of the UBOOT code 1002 and blocks of the application 1004 when the application starts.

For sake of brevity, the example of FIG. 10 shows a boot record of only one log for a total three blocks. In the diagram, free blocks are denoted “FB,” blocks when the log is dumped are denoted “DB,” and logs stored but not dumped are denoted “SB.”

The boot record keeps one bit field as the state to indicate whether a corresponding record has been dumped by the application. For the example of FIG. 10, it can be seen that the system ran into a one-time power cycle due to “i2c failure” and two times power cycle due to “pci-e init”, and four times power cycle due to “usb init.”

Upon taking an abnormal operation log into flash for a same reason as previously, the system only takes the same block and only updates the state field instead of inserting new log into new block. As shown in FIG. 10, block #1 and block #2 will not be used for such a case.

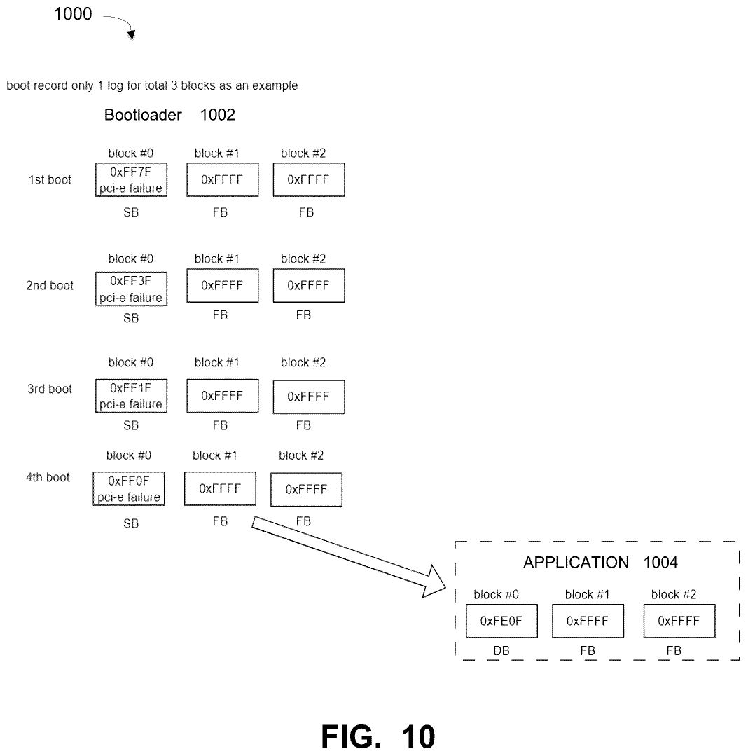

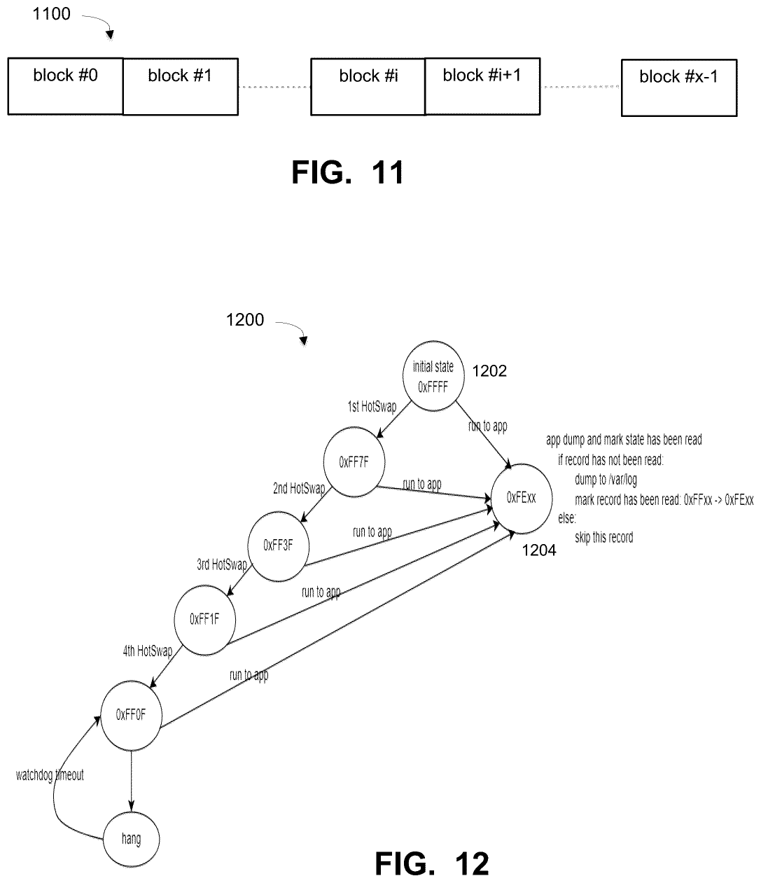

With reference back to FIG. 6, process 600 finds the last valid block of flash to append a new log, 606. Such a process can be used to add a new abnormal operation log to flash memory. FIG. 11 illustrates an example of finding a last valid block, under some embodiments. As shown in diagram 1100, block 0 to block i have data that has been previously recorded. In this case, the last valid block (block with valid data) is block i. follow data layout, from 0-th to i-th block, all has been recorded before, so the last valid block index should be #i.

In an embodiment, a binary search to locate the first free block, last valid block, and last fetched block. The process of finding the last valid block is similar to finding the first free block. A binary search is applied to speed it up the operation. A valid block means it is not all 1s, and signatures and CRC checksums match. In a binary search, suppose all blocks start from #x to #y. The process first finds the middle block (#x+ #y)/2 of all blocks. If the middle block is valid, then binary search from (#x+ #y)/2 to #y, otherwise, binary search from #x to (#x+ #y)/2.

The first free block, as determined in step 608 of FIG. 6, is the first block after the last valid block. This block is used to add a new log to the appropriate partition (e.g., boot log or abnormal operation). For the embodiment of FIG. 11, the first free block is thus block i+1.

Once the first free block is identified, the process adds a new log that is recorded when boot loader does hardware/software initialization during boot-up, 610. For this operation, the process locates the valid block index to be record and applies the find first free block function. If there is no free block, log will not be recorded, otherwise, the log will be recorded in-sequence to this block (e.g., block i+1).

In the case of an abnormal operation, the process records the abnormal operation log to the abnormal operation log space, 612. Such a log is recorded when there is a need to do an abnormal operation, such as power cycle the system in the event of a hardware initialization failure. For abnormal operations, the boot loader may sometimes run into a same situation. For example, due to a hardware fault, the system cannot be recovered or even power cycled within the boot loader. In this case, if the system always records a new log, that partition will become full and have no free blocks for use. To limit such cases, the system includes a new finite state machine to save flash lifetime.

For this step, unlike the startup log, the abnormal operation log procedure involves several extra steps involving state changes for each record. FIG. 12 illustrates an example of recording an abnormal operation log, under an embodiment. Diagram 1200 of FIG. 12 shows an initial state 1202 as it is processed through a number of abnormal operations to reach a final state 1204. As shown in FIG. 12, within the record header, a member “state” is encoded as follows:
0xFFFF: initial state
0xFF7F: 1^{st} try abnormal operation with same reason.
0xFF3F: 2^{nd} try abnormal operation with same reason.
0xFF1F: 3^{rd} try abnormal operation with same reason.
0xFFOF: last try abnormal operation with same reason.
0xFExF: this log has been fetched by application.

For example, when there is a need to power cycle once boot loader detected PCI-E hung, it would record to flash a message such as: “PCI-E HUNG”. It will record “PCI-E HUNG” into flash record and the first time, this log's state will be “0xFFFF.” If the system encounters a PCI-E hung condition again after the power cycle, it will read last valid log and check the reason whether is “PCI-E HUNG.” If it is true, it will update the same block's header state to 0xFF7F, and try again until the state changed to “0xFFOF.” Only a change bit state 1 to bit state 0, can guarantee no need to erase the whole sector.

With respect to the abnormal log operation, the process locates the last valid block and checks the state and operation log. If the operation log is duplicated as current and its state is under try, the current operation log will not be recorded, otherwise, it will locate the last free block as upon algorithm and record the current operation log into the first free block.

As shown in step 614 of FIG. 6, upon a system boot, the application dumps logs from previous boot ups or abnormal operation logs. It only dumps the logs never fetched by previous boot. For example, if the system encounters a PCI-E initialization failure and tries an abnormal operation one time, the system recovers to a normal state. After the system boots up normally, the application will dump the initialization logs before and after the abnormal operation. There will be two similar initialization logs, from the initialization logs, software/hardware will know the condition during the first initialization logs. The process will avoid dumping useless logs that have happened before, and only dumps the previous logs not previously fetched.

FIG. 13 is an example of dumping application logs, under an embodiment. FIG. 13 shows a first set of blocks 1302 prior to dumping and 1304 after dumping. For the example shown, if during boot up, the system recorded from “#(x+2)” to “#y”, once the application starts, it dumped from “#(x+2)” to “#y”, and updates these blocks' state from 1 to 0 (i.e., 0xFFFF to 0xFEFF).

As to the example of FIG. 13, portion 1302 represents the state field of the log header, the state of both block #x and block #(x+1) is 0xFEFF, which means that they have been dumped before this boot procedure. In the current boot procedure, the boot loader recorded some new logs from block #(x+2) to block #y, and these logs' header state value are all 0xFFFF. Once the system boots into an application, the application will scan blocks and dump the logs from block #(x+2) to #y. After this dump, the application will update one bit the state field from 1 to 0 as shown in an example 0xFFFF to 0xFEFF in portion 1304 of FIG. 13. This represents the state field change when the application dumped the boot logs.

As shown in step 616 of FIG. 6, once the system boots to the application, the application will check whether the whole partition is full or not. Once the partition is full, it will erase whole partition (by sectors, as flash is erased by sector units) for a next reboot operation to store logs (bootup/abnormal operation). FIG. 14 illustrates erasing sectors in a cleanup operation, under some embodiments.

FIG. 14 shows three example sectors, sector 0, sector 1 and sector 2. The cleanup operation 1402 erases the sectors in reverse order, such as from sector 2 to sector 0. Since the cleanup operation needs to erase from last sector to first sector, this can guarantee it will not break the binary search once a reboot happens during the erase operation. For example, if there are only three sectors in total, when all these blocks have been used, it needs to erase from sector 2 to sector 0.

The logs can ultimately be provided to a user or debugging tools for product improvement, and so on, 618.

Embodiments thus provide a high efficiency process to add a new log to flash through an applied binary search algorithm. The binary search locates the first free block, last valid block, last fetched block. A state machine is used to avoid record duplicate abnormal operation history. Duplicate log records are avoided when doing the same abnormal operation during boot up. No special management module is needed to organize all data blocks. There are no sector erases during record new log to save flash lifetime, and no dependency on file system or operating system APIs.

As stated above, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described herein. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor” or “controller” as used herein may refer to any of the foregoing structures or any other structure suitable for implementation of the techniques described herein. Also, the techniques could be fully implemented in one or more circuits or logic elements.

The techniques of this disclosure may be implemented in a wide variety of devices or apparatuses, including an IC or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for logging boot and abnormal operations in an embedded system having non-volatile memory partitioned into a startup log partition and an abnormal operation log partition, comprising:
executing a boot loader process to execute boot code to start up the embedded system;
storing boot event records of the boot loader process in the startup log partition; and
storing abnormal event records in the abnormal operation log partition for any abnormal events encountered during the start up.

2. The method of claim 1 wherein the boot loader initializes system hardware and loads an operating system into memory.

3. The method of claim 2 wherein the system hardware includes one or more peripheral devices used by the embedded system, and coupled to the embedded system through respective logical and physical interfaces.

4. The method of claim 3 wherein the abnormal events comprise at least one of a failure of a peripheral device, a failure of a logical or physical interface, or a failure of hardware or software performing the start up.

5. The method of claim 1 further comprising defining a record header for each record stored in the non-volatile memory, the header containing a state, signature, version, payload length, and cyclic redundancy check and a state of a respective record, and wherein the state comprises the status of a corresponding record.

6. The method of claim 5 wherein the state comprises the status of a corresponding record, and further comprising maintaining, in the boot record, a one-bit field indicating whether record has been dumped by an application.

7. The method of claim 5 further comprising identifying a next available block to store a new record within the startup log partition or abnormal operation log partition.

8. The method of claim 7 wherein the identifying step comprises using a binary search operation.

9. The method of claim 6 wherein the state transitions between bit states 0 and 1 upon logging a repetitive abnormal operation to prevent storage of duplicative abnormal operation logs in the abnormal operation log partition.

10. The method of claim 7 further comprising:
checking, by the application, whether or not a partition is full; and
erasing, for a full partition, in a cleanup operation the entire partition by sectors for a next reboot operation to store logs.

11. The method of claim 10 wherein the cleanup operation erases the sectors in reverse order, the method further comprising providing the boot event records to a user or set of debugging tools for product improvement.

12. A system for storing boot logs in non-volatile memory of an embedded system, comprising:
a boot loader component executing boot code using a processor of the embedded system to initialize system hardware and load an operating system into memory;
a non-volatile memory storing the boot code, and comprising a first region storing blocks for boot event records, and a second region storing blocks for operation failure records; and
an interface to transmit the boot event records and operation failure records to a user for system review purposes.

13. The system of claim 12 further comprising processing logic configured to locate a next available block for writing a new record into the non-volatile memory through a binary search operation within the first region or second region.

14. The system of claim 13 wherein the blocks further comprise a record header containing a cyclic redundancy check and a state.

15. The system of claim 14 wherein the state transitions upon logging a repetitive failure to avoid duplicate records.

16. The system of claim 15 wherein the system hardware includes one or more peripheral devices used by the embedded system, and coupled to the embedded system through respective logical and physical interfaces, and wherein a failure comprises at least one of a failure of a peripheral device, a failure of a logical or physical interface, or a failure of hardware or software performing the start up.

17. A method for boot logging in embedded devices, the method comprising:
executing a boot loader sequence on a processor;
appending boot event records to a first region in non-volatile memory;
locating available blocks in the first region for new records without erase operations; and
extracting boot records after successful system startup.

18. The method of claim 17 further comprising transitioning the state in a record header if logging a duplicate failure event.

19. The method of claim 18 wherein appending records further comprises writing record headers containing CRC values and sequence numbers.

20. The method of claim 19 wherein the embedded devices comprise a system including one or more peripheral devices coupled through respective logical and physical interfaces, and wherein a failure comprises at least one of a failure of a peripheral device, a failure of a logical or physical interface, or a failure of hardware or software performing the start up.
